(19) United States
(12) Patent Application Publication
(10) Pub. No.: US 2015/0151752 A1
(43) Pub. Date: Jun. 4, 2015

(54) METHOD FOR DETERMINING LATERAL DIRECTION DISTANCE OF PRECEDING VEHICLE, AND HEADS-UP DISPLAY SYSTEM USING THE SAME

(71) Applicant: Hyundai Motor Company, Seoul (KR)

(72) Inventor: Jong Bok LEE, Yongin-si (KR)

(21) Appl. No.: 14/340,200

(22) Filed: Jul. 24, 2014

(30) Foreign Application Priority Data
Dec. 2, 2013 (KR) 10-2013-0148726

(51) Int. Cl. B60W 30/14; B60R 1/00; G06T 19/00; B60W 40/072; G01B 21/16

(52) U.S. Cl. CPC B60W 30/14; B60W 40/072; G01B 21/16; G06T 19/006; B60R 1/00; B60R 2300/205; B60R 2300/302; B60R 2300/802

(57) ABSTRACT

A method for determining a lateral direction distance of a preceding vehicle and a heads-up display (HUD) system using the same are disclosed. The method may include steps of detecting input variables, determining whether a determination condition of a lateral direction distance is satisfied, and determining a lateral direction distance of the preceding vehicle based on the input variables if the determination condition of the lateral distance is satisfied.

### CROSS-REFERENCE TO RELATED APPLICATION

This application claims the benefit of priority to Korean Patent Application No. 10-2013-0148726 filed in the Korean Intellectual Property Office on Dec. 2, 2013, the entire contents of which are incorporated herein by reference.

### TECHNICAL FIELD

The present disclosure relates to a heads-up display (HUD) system. More particularly, the present disclosure relates to a method for determining a lateral direction distance of a preceding vehicle and a heads-up display system using the same.

### BACKGROUND

In general, a heads-up display (HUD) system has been developed to provide flight information to an airplane pilot, and the HUD system is mounted in an aircraft. Recently, the HUD system has been applied to a vehicle to conveniently notify driving information of the vehicle to a driver. With driving information such as speed or fuel amount of the vehicle and image information such as rear vision being projected on a windshield glass instead of on an instrument panel, the driver can easily recognize the information while focusing on a front view, thus securing driver's safety.

In a case where a preceding vehicle drives on a curved road, as a distance between a host vehicle and the preceding vehicle is increased, the preceding vehicle is viewed as if driving on the curved road in parallel at a certain distance in a lateral direction. Conventional HUD systems use a map-matching method for providing a position of the preceding vehicle and navigation information. A global positioning system (GPS) generally has a distance error of several meters to tens of meters, such that there is a limit in accurately recognizing a lane due to the error accumulated in accordance with the distance from a base station.

The conventional art determines a coordinate of a centerline of a road as a current position of the host vehicle and cannot determine the lane where the host vehicle travels. That is, it is difficult to correct a lateral error between an actual position of the preceding vehicle and a display position displayed on the windshield glass as a graphic image.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to provide a method for determining a lateral direction distance of a preceding vehicle and a heads-up display (HUD) system using the same having advantages of accurately displaying a position of the preceding vehicle as a graphic image.

According to an exemplary embodiment of the present disclosure, a method for determining a lateral direction distance of a preceding vehicle may include steps of detecting input variables, determining whether a determination condition of the lateral direction distance is satisfied, and determining the lateral direction distance of the preceding vehicle based on the input variables if the determination condition of the lateral direction distance is satisfied.

The determination condition of the lateral direction distance may be satisfied if a host vehicle travels in an innermost lane or an outermost lane of a road.

The input variables may include a curvature radius of the road, a distance between the host vehicle and the preceding vehicle, and a lane width of the road.

The lateral direction distance Dₚ of the preceding vehicle is calculated by an equation of

$${D}_{p} = {R}_{2} \times ( 1 - cos ( \frac{360 \times {D}_{f}}{2 \times π \times {R}_{1}} ) ) ,$$

wherein R₁ denotes the curvature radius of the road, D_{f} denotes the distance between the host vehicle and the preceding vehicle, and R₂ denotes a sum of the curvature radius of the road and the lane width of the road.

The method may further include determining whether the curvature radius of the road is smaller than or equal to a set curvature radius, wherein, if the curvature radius of the road is smaller than or equal to the set curvature radius, the determining of whether the determination condition of the lateral direction distance is satisfied is performed.

The method may further include a step of correcting a display position of the preceding vehicle displayed on a windshield glass as a graphic image based on the determined lateral direction distance.

According to another exemplary embodiment of the present disclosure, a heads-up display (HUD) system may include a plurality of side sensors configured to detect an obstacle located at a side of a host vehicle. A front sensor is configured to detect a distance between the host vehicle and a preceding vehicle. A navigator is configured to provide road information including a curvature radius of a road, the number of road lanes, and a lane width of the road. An image generator is configured to display a position of the preceding vehicle on a windshield glass as a graphic image. A controller is configured to receive input variables from the plurality of side sensors, the front sensor, and the navigator, and to determine a lateral direction distance of the preceding vehicle based on the input variables. The controller corrects the position of the preceding vehicle displayed as the graphic image based on the determined lateral direction distance of the preceding vehicle.

The controller may determine the lateral direction distance of the preceding vehicle only if the host vehicle travels in an innermost lane or an outermost lane of the road.

The input variables may include the curvature radius of the road, the distance between the host vehicle and the preceding vehicle, and the lane width of the road.

The controller may calculate the lateral direction distance Dₚ of the preceding vehicle by an equation of

$${D}_{p} = {R}_{2} \times ( 1 - cos ( \frac{360 \times {D}_{f}}{2 \times π \times {R}_{1}} ) ) ,$$

wherein R₁ denotes the curvature radius of the road, D_{f} denotes the distance between the host vehicle and the preceding vehicle, and R₂ denotes a sum of the curvature radius of the road and the lane width of the road.

The controller may determine the lateral direction distance of the preceding vehicle if the curvature radius of the road is smaller than or equal to a set curvature radius.

According to an exemplary embodiment of the present disclosure, it is possible to determine the lateral direction distance of the preceding vehicle accurately, thereby reducing a lateral error between an actual position of the preceding vehicle and a display position displayed on the windshield glass as a graphic image.

### BRIEF DESCRIPTION OF THE DRAWINGS

FIG. 1 is a block diagram of a heads-up display (HUD) system according to an exemplary embodiment of the present disclosure.

FIG. 2 is a flowchart of a method for determining a lateral direction distance of a preceding vehicle according to an exemplary embodiment of the present disclosure.

FIG. 3 is a drawing for describing a method for determining a lane where a host vehicle travels according to an exemplary embodiment of the present disclosure.

FIG. 4 is a drawing for describing a method for determining a lateral direction distance of a preceding vehicle according to an exemplary embodiment of the present disclosure.

### DETAILED DESCRIPTION

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

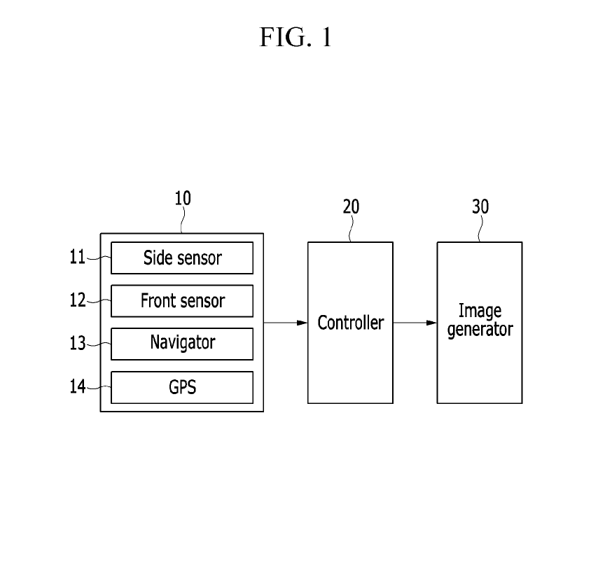

FIG. 1 is a block diagram of a heads-up display (HUD) system according to an exemplary embodiment of the present disclosure. As shown in FIG. 1, the HUD system according to an exemplary embodiment of the present disclosure includes a data detector 10, a controller 20, and an image generator 30.

The data detector 10 detects data for determining a lateral direction distance of a preceding vehicle, and the data detected by the data detector 10 is transmitted to the controller 20. The data detector 10 includes a plurality of side sensors 11, a front sensor 12, a navigator 13, and a global positioning system (GPS) 14.

The side sensors 11 may be provided at each of front left and front right sides of a host vehicle, and may be ultrasonic wave sensors so as to detect an obstacle located at a left side or a right side of the host vehicle. However, it is sufficient in an exemplary embodiment of the present disclosure that the side sensors 11 can detect the obstacle located at the left side or the right side of the host vehicle. Therefore, it is to be understood that the side sensors 11 include any device which can detect the obstacle in this specification and the claims.

The front sensor 12 detects a distance between the host vehicle and the preceding vehicle. The front sensor 12 may be a radar sensor which is used in a smart cruise control (SCC) system, but the scope of the present disclosure is not limited thereto. It is sufficient in an exemplary embodiment of the present disclosure that the front sensor 12 can detect the distance between the host vehicle and the preceding vehicle. Therefore, it is to be understood that the front sensor 12 includes any device which can detect the distance in this specification and the claims.

The navigator 13 informs the driver of a route to a destination. The navigator 13 includes an input/output inputting or outputting information for route guidance, a current position detector detecting information on a current position of the host vehicle, a memory in which map data for calculating the route and data for guiding the route are stored, and a controller for searching the route and performing the route guidance. However, it is sufficient in an exemplary embodiment of the present disclosure that the navigator 13 can provide information on a road shape such as a curvature radius of the road, the number of road lanes, and a lane width of the road to the controller 20. Therefore, it is to be understood that the navigator 13 includes any device which can provide the information on the road shape to the controller 20 in this specification and the claims.

The GPS 14 receives a signal transmitted from a GPS satellite and transmits the corresponding signal to the navigator 13. The controller 20 determines the lateral direction distance of the preceding vehicle based on the data detected by the data detector 10. The controller 20 may calculate the lateral direction distance of the preceding vehicle in a case where the host vehicle travels in the innermost lane or the outermost lane of the road.

In this specification, the lateral direction distance of the preceding vehicle means a distance that the preceding vehicle is moved to the left or the right from an imaginary line, which is extended in a traveling direction of the host vehicle from the center of the host vehicle, when the preceding vehicle travels in the same lane where the host vehicle travels.

The controller 20 may be implemented with one or more microprocessors executed by a predetermined program. The predetermined program may include a series of commands for performing each step included in a method for determining the lateral direction distance of the preceding vehicle according to an exemplary embodiment of the present disclosure.

The controller 20 controls the image generator 30 depending on the calculated lateral direction distance of the preceding vehicle. That is, the controller 20 may correct the display position of the preceding vehicle based on the calculated lateral direction distance of the preceding vehicle.

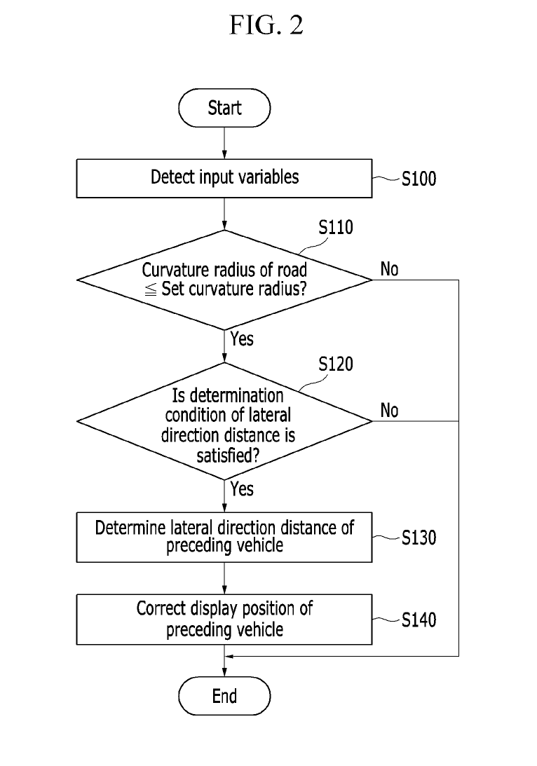

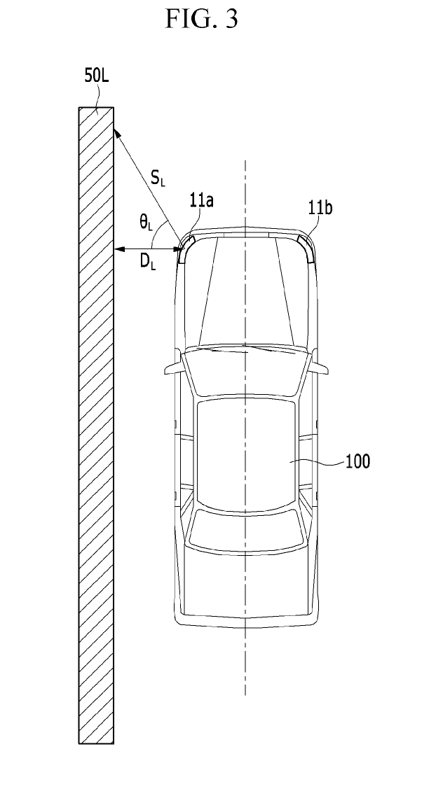

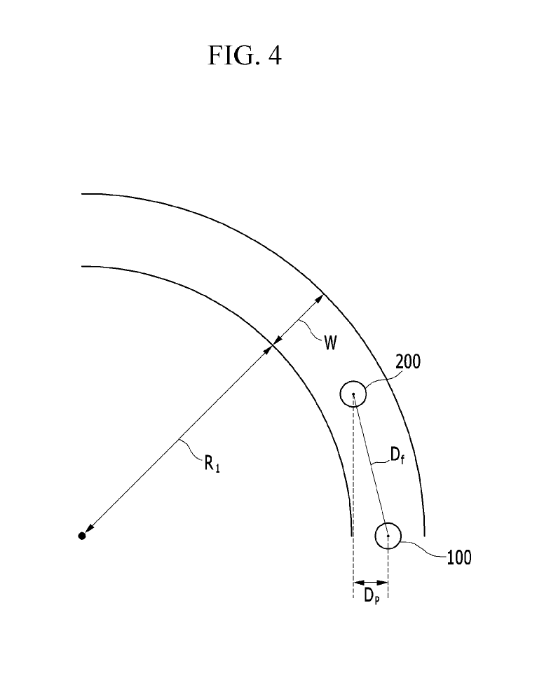

Hereinafter, referring to FIGS. 2 to 4, a method for determining a lateral direction distance of a preceding vehicle according to an exemplary embodiment of the present disclosure will be described in detail. FIG. 2 is a flowchart for determining a lateral direction distance of a preceding vehicle according to an exemplary embodiment of the present disclosure. FIG. 3 is a drawing for describing a method for determining a lane where a host vehicle travels according to an exemplary embodiment of the present disclosure. FIG. 4 is a drawing for describing a method for determining a lateral direction distance of a preceding vehicle according to an exemplary embodiment of the present disclosure.

As shown in FIG. 2, the method for determining the lateral direction distance of the preceding vehicle according to an exemplary embodiment of the present disclosure begins with detecting input variables at step S100.

When the data detector 10 detects data and transmits the data to the controller 20, the controller 20 may determine whether the curvature radius of the road is smaller than or equal to a set curvature radius at step S110. The set curvature radius can be arbitrarily set by a person of ordinary skill in the art in consideration of a lateral error. That is, if the curvature radius is too large (e.g., a straight road), the lateral direction distance may not be determined because the lateral error is not large, thereby reducing a calculation load of the controller 20. The controller 20 finishes the method for determining the lateral direction distance of the preceding vehicle according to the exemplary embodiment of the present disclosure if the curvature radius of the road is larger than the set curvature radius.

At step S110, if the curvature radius is smaller than or equal to the set curvature radius, the controller 20 determines whether the determination condition of the lateral direction distance is satisfied at step S120. The determination condition of the lateral direction distance is satisfied if the host vehicle travels in the innermost lane or the outermost lane of the road. For example, as shown in FIG. 3, the controller 20 determines that the host vehicle 100 travels in the innermost lane if the distance D_{L} between the host vehicle and a left fixed object 50L is smaller than or equal to a set distance. The left fixed object 50L may be a central median.

Although the central median is exemplified as the fixed object at the left of the host vehicle in an exemplary embodiment of the present disclosure, the scope of the present disclosure is not limited thereto. If another means that divides the road about the center is used, though different from the central median, the scope of the present disclosure can still be applied.

The controller 20 may determine whether the host vehicle travels in the innermost lane based on a sensing value S_{L} which is received from the side sensor 11a provided in the left front side of the host vehicle 100. The set distance can be arbitrarily set by a person of ordinary skill in the art, and may be about 1.5 m.

The controller 20 may calculate the distance D_{L} between the host vehicle and the left fixed object 50L according to the following equation.

D_{L}=S_{L}×cos(θ_{L})

where, S_{L} denotes a sensing value of the side sensor 11a, and θ_{L} denotes an angle between a sense direction of the side sensor 11a and a direction perpendicular to the traveling direction of the host vehicle 100.

In addition, the controller 20 determines that the host vehicle 100 travels in the outermost lane if a distance between the host vehicle 100 and a right fixed object is smaller than or equal to the set distance by the same method as the method for determining whether the host vehicle 100 travels in the innermost lane. The right fixed object may be a guard rail.

If the determination condition of the lateral direction distance is not satisfied in step S120, the controller 20 ends the method for determining the lateral direction distance of the preceding vehicle according to an exemplary embodiment of the present disclosure. If the determination condition of the lateral direction distance is satisfied at step S120, the controller 20 determines the lateral direction distance of the preceding vehicle at step S130.

The controller 20 may determine the lateral direction distance D_{P} of the preceding vehicle 200 as shown in FIG. 4. The lateral direction distance Dₚ of the preceding vehicle 200 may be calculated according to the following equations.

$${D}_{p} = {R}_{2} \times ( 1 - cos ( \frac{360 \times {D}_{f}}{2 \times π \times {R}_{1}} ) )$$

$${R}_{2} = {R}_{1} + W$$

where, R₁ denotes a curvature radius of a road, D_{f} denotes a distance between the host vehicle 100 and the preceding vehicle 200, W denotes a lane width of the road, and R₂ is the sum of the curvature radius R₁ and the lane width W.

The controller 20 controls the image generator 30 based on the lateral direction distance of the preceding vehicle. That is, the controller 20 may correct a display position of the preceding vehicle displayed on a windshield glass as a graphic image based on the calculated lateral direction distance of the preceding vehicle at step S140.

As described above, according to an exemplary embodiment of the present disclosure, it is possible to accurately determine the lateral direction distance of the preceding vehicle, thereby reducing the lateral error between an actual position of the preceding vehicle and a display position displayed on the windshield glass as a graphic image.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A method for determining a lateral direction distance of a preceding vehicle, the method comprising steps of:
detecting input variables;
determining whether a determination condition of the lateral direction distance is satisfied; and
determining the lateral direction distance of the preceding vehicle based on the input variables if the determination condition of the lateral direction distance is satisfied.

2. The method of claim 1, wherein the determination condition of the lateral direction distance is satisfied if a host vehicle travels in an innermost lane or an outermost lane of a road.

3. The method of claim 1, wherein the input variables comprise a curvature radius of a road, a distance between a host vehicle and the preceding vehicle, and a lane width of the road.

4. The method of claim 3, wherein the lateral direction distance Dₚ of the preceding vehicle is calculated by an equation of
$${D}_{p} = {R}_{2} \times ( 1 - cos ( \frac{360 \times {D}_{f}}{2 \times π \times {R}_{1}} ) ) ,$$
wherein R₁ denotes the curvature radius of the road, D_{f} denotes the distance between the host vehicle and the preceding vehicle, and R₂ denotes a sum of the curvature radius of the road and the lane width of the road.

5. The method of claim 3, further comprising a step of determining whether the curvature radius of the road is smaller than or equal to a set curvature radius,
wherein if the curvature radius of the road is smaller than or equal to the set curvature radius, the step of determining whether the determination condition of the lateral direction distance is satisfied is performed.

6. The method of claim 1, further comprising a step of correcting a position of the preceding vehicle displayed on a windshield glass as a graphic image based on the determined lateral direction distance.

7. A heads-up display (HUD) system comprising:
a plurality of side sensors configured to detect an obstacle located at a side of a host vehicle;
a front sensor configured to detect a distance between the host vehicle and a preceding vehicle;
a navigator configured to provide road information including a curvature radius of a road, the number of road lanes, and a lane width of the road;
an image generator configured to display a position of the preceding vehicle on a windshield glass as a graphic image; and
a controller configured to receive input variables from the plurality of side sensors, the front sensor, and the navigator, and to determine a lateral direction distance of the preceding vehicle based on the input variables,
wherein the controller corrects the position of the preceding vehicle displayed as the graphic image based on the determined lateral direction distance of the preceding vehicle.

8. The HUD system of claim 7, wherein the controller determines the lateral direction distance of the preceding vehicle only if the host vehicle travels in an innermost lane or an outermost lane of the road.

9. The HUD system of claim 7, wherein the input variables comprise the curvature radius of the road, the distance between the host vehicle and the preceding vehicle, and the lane width of the road.

10. The HUD system of claim 9, wherein the controller calculates the lateral direction distance of the preceding vehicle by an equation of
$${D}_{p} = {R}_{2} \times ( 1 - cos ( \frac{360 \times {D}_{f}}{2 \times π \times {R}_{1}} ) ) ,$$
wherein R₁ denotes the curvature radius of the road, D_{f} denotes the distance between the host vehicle and the preceding vehicle, and R₂ denotes a sum of the curvature radius of the road and the lane width of the road.

11. The HUD system of claim 9, wherein the controller determines the lateral direction distance of the preceding vehicle if the curvature radius of the road is smaller than or equal to a set curvature radius.
